(19) United States
(12) Patent Application Publication
(10) Pub. No.: US 2026/0288114 A1
(43) Pub. Date: Sep. 24, 2026

(54) Machinery Motion Primitive

(71) Applicant: FANUC CORPORATION, Yamanashi (JP)

(72) Inventors: Hsien-Chung Lin, Fremont, CA (US); Tetsuaki Kato, Union City, CA (US)

(21) Appl. No.: 19/085,286

(22) Filed: Mar. 20, 2025

(51) Int. Cl. G05B 19/4155

(52) U.S. Cl. CPC G05B 19/4155; G05B 2219/34216; G05B 2219/45129

(57) ABSTRACT

A method for programming a multi-segment motion plan for a machine tool which uses a set of motion primitives as building blocks. The motion plan is computed with rapid motion planning techniques, where non-static boundary conditions states—velocities at the end of one step and the beginning of the next—can be solved for the entire multi-step sequence by the disclosed programming language software. This eliminates stopping the machine tool between steps, and results in a time-optimal performance of the machining operation. The motion primitives include retreating from a hole, air cutting up, air cutting in a lateral direction, air cutting down, and drilling a hole. More complex machining operations, such as drilling a sequence of holes in a workpiece, can be built up from the basic motion primitives.

### BACKGROUND

### Field

The present disclosure relates generally to the field of machine tool motion control and, more particularly, to a method for programming a machine tool motion plan which uses motion primitives to define a machining operation, where the motion primitives include variable and non-static boundary condition states which can be optimized by programming language software, eliminating stopping the machine tool between steps, to result in a minimum cycle time for performance of the machining operation.

### Discussion of the Related Art

It is known in the art to use computer-controlled devices to perform machining operations, such as drilling and milling, on parts. In some applications, computer numerical controlled (CNC) machines are used which move a tool along a path in three dimensions while the tool maintains a fixed spatial orientation. In other applications, a multi-axis industrial robot is fitted with a machining head, and the robot can move the tool along a spatial path while also controlling the tool orientation to any desired value.

Regardless of what type of machine tool or robot is used to perform the machining operation, a tool path trajectory and corresponding velocity profile must be computed. The tool path trajectory includes both machining steps (when the tool is cutting material from the workpiece, such as drilling a hole or milling) and “air cut” movement steps (where, before or after a machining step, the tool is moved through air to a point at the beginning of the next machining step).

The computed tool path trajectory must of course accurately perform the desired machining steps on the workpiece (i.e., provide the desired shape of the completed workpiece, with holes in the correct locations, etc.), and must also adhere to constraints such as mechanical limits of the machine, and a specified feed speed when drilling or milling.

In addition, it is desirable to compute the tool path trajectory and velocity profile which provides the fastest possible cycle time for the overall machining operation, in order to maximize machine productivity. And finally, it is imperative to ensure that the tool path trajectory is collision-free—that is, that the tool and the machine avoid collisions with the workpiece itself or with a fixture or any other obstacle in the workspace.

Techniques are known in the art which, given specified start and goal locations for a single step, can compute a trajectory and corresponding velocity profile which optimizes cycle time. However, these techniques cannot optimize the total cycle time for a multi-segment trajectory. Furthermore, some trajectory computation techniques cannot accommodate collision avoidance determinations in the trajectory calculation.

Other techniques exist which can accommodate collision avoidance determinations in the trajectory calculation, but these existing techniques do not optimize cycle time. For example, one known method monitors for collisions in real time and, if an imminent collision is detected, stops the machine in order to prevent the collision. Another known method requires computation of multiple tool path trajectories in advance, and selects one of the predefined trajectories based on the obstacle environment for a particular operation. Still another method uses an imaging system to detect potential collisions in real time and adjusts the trajectory accordingly, but cannot optimize cycle time of the operation while doing so.

Additionally, existing machine tool programming languages simply allow point to point tool movement, with the tool stopping at each point, and no option to allow programming language software to compute optimal boundary condition states for a multi-step machining operation.

In light of the circumstances described above, there is a need for an improved machine tool programming method where motion primitives may be defined with variable boundary condition states and a time-optimal trajectory computation is automatically performed, with optional collision avoidance planning also handled automatically.

### SUMMARY

The present disclosure describes a method for programming a multi-segment motion plan for a machine tool which uses a set of motion primitives as building blocks. The motion plan is computed with rapid motion planning techniques, where non-static boundary conditions states—velocities at the end of one step and the beginning of the next—can be solved for the entire multi-step sequence by the disclosed programming language software. This eliminates stopping the machine tool between steps, and results in a time-optimal performance of the machining operation. The motion primitives include retreating from a hole, air cutting up, air cutting in a lateral direction, air cutting down, and drilling a hole. More complex machining operations, such as drilling a sequence of holes in a workpiece, can be built up from the basic motion primitives.

Additional features of the presently disclosed systems and methods will become apparent from the following description and appended claims, taken in conjunction with the accompanying drawings.

### BRIEF DESCRIPTION OF THE DRAWINGS

FIG. 1 is a cross-sectional illustration of a workpiece machining operation and the basic concepts involved in motion planning for the operation, along with the machine tool system performing the operation;

FIG. 2 is a cross-sectional illustration of a workpiece and a machining operation involving two holes as in FIG. 1, and depicting a time-optimal trajectory for moving the tool from the first hole to the second hole;

FIG. 3 is an illustration of a set of motion primitives which may be used in combinations to program a multi-step machining operation on a machine tool, where a programming language computes a time-optimal tool motion from the motion primitives including non-static transitions between steps, according to embodiments of the present disclosure;

FIG. 4 is an illustration of a multi-step machining operation performed using the motion primitives in a machining program according to embodiments of the present disclosure, along with a corresponding graph of the tool trajectory in workspace coordinates showing how the motion primitives are represented in the tool motion;

FIG. 5 is an illustration of a sequence of some of the motion primitives of FIG. 3 which may be used for a pecking-type drilling operation, where the pecking operation drills a hole in stages of increasing depth, and the programming language computes a time-optimal tool motion from the motion primitives including non-static transitions between steps, according to embodiments of the present disclosure;

FIG. 6 includes a graph of position versus time for a pecking operation using traditional machining program methods, and a graph of position versus time for the pecking operation using the sequence of motion primitives illustrated in FIG. 5 according to embodiments of the present disclosure;

FIG. 7 is an illustration of three variations of the Drill motion primitive, including constant speed drilling as discussed in connection with FIG. 3, and two different types of speed change during drilling, according to embodiments of the present disclosure;

FIG. 8 is a flowchart diagram of a method for motion programming of a machine tool, where a programming language includes motion primitives which are used in sequence in a machining program, and a programming language software application computes a time-optimal motion plan from the machining program, according to embodiments of the present disclosure;

FIG. 9 is an illustration of a two-hole drilling operation using motion primitives in an environment with an obstacle, along with a flowchart diagram of a method for time-optimal collision-free motion planning using a programming language software application with motion primitives in a machining program, according to embodiments of the present disclosure;

FIG. 10 is an illustration of a collision avoidance tool trajectory computed using traditional motion planning methods, and a collision avoidance tool trajectory computed using the programming language software with motion primitives and automatic collision avoidance planning according to embodiments of the present disclosure;

FIG. 11 is an illustration of a hole drilling operation with an initial approach step using motion primitives in an environment with an obstacle, along with a flowchart diagram of a method for time-optimal collision-free motion planning using a programming language software application with motion primitives in a machining program, according to other embodiments of the present disclosure; and

FIG. 12 is an illustration of a collision avoidance tool trajectory computed using traditional motion planning methods, and collision avoidance tool trajectories computed with different time delays using the programming language software with motion primitives and automatic collision avoidance planning according to embodiments of the present disclosure.

### DETAILED DESCRIPTION OF THE EMBODIMENTS

The following discussion of the embodiments of the disclosure directed to machinery motion primitives is merely exemplary in nature, and is in no way intended to limit the disclosed devices and techniques or their applications or uses.

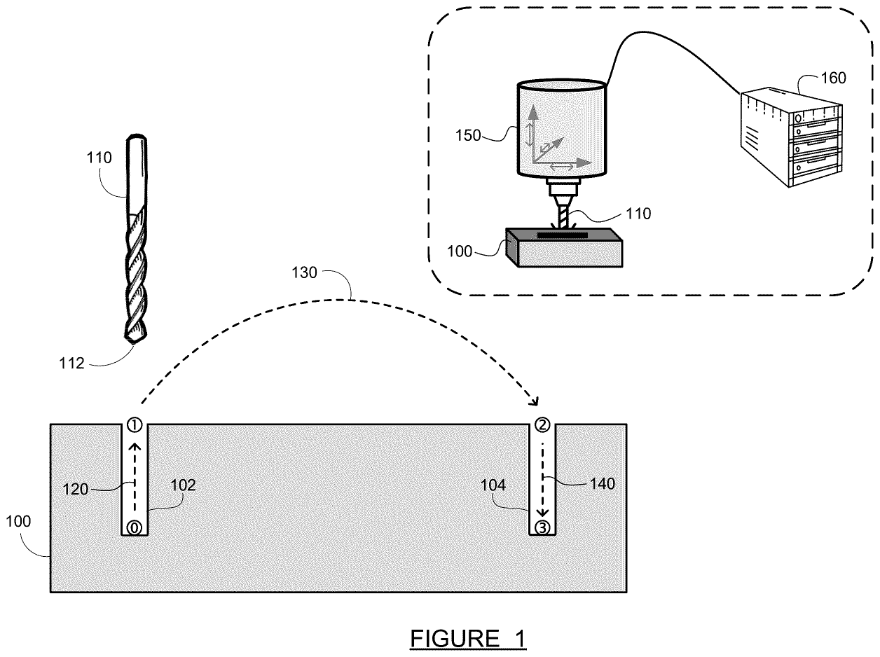

FIG. 1 is a cross-sectional illustration of a workpiece machining operation and the basic concepts involved in motion planning for the operation. FIG. 1 is provided as a basis for describing the type of machining operation which is the subject of the present disclosure. A workpiece 100 is typically held in a fixed position by clamps or fixtures, and the workpiece 100 is machined by a tool 110 having a tip 112. The tool 110, which could be a drill or a mill for example, is operated by a programmatically controlled machine tool 150 (shown in the inset at top right)—which could be a CNC machine or a multi-axis industrial robot. In the example shown in FIG. 1 and discussed throughout the present disclosure, the tool 110 has a fixed orientation (i.e., always vertical as seen in FIG. 1; does not tilt). The machine tool 150 is controlled by a controller 160, which has a motion program (a series of cutting steps and air cut steps) programmed on it. The efficient programming of the controller 160 to perform time-optimal machining operations is the subject of the present disclosure.

The machining operation depicted in FIG. 1 is drilling two holes—a hole 102 and a hole 104—into the workpiece 100. The holes 102 and 104 are shown as already drilled for illustration purposes. The tool 110 is first positioned approximately as shown in FIG. 1, moved vertically downward until it contacts the workpiece 100, and the hole 102 is drilled in a known manner.

The drilling step along with the remaining steps of the operation—moving the tool 110 out of the hole 102, moving the tool 110 into position at the top of and then drilling the hole 104—are steps which are commonly performed in machining operations, and will be discussed later in the context of the disclosed motion primitives. After drilling, the next operation is moving the tip 112 of the tool 110 from a waypoint \textcircled{0} at the bottom of the hole 102 upward along a path 120 to a waypoint \textcircled{1} at the top of the hole 102. The tool 110 can be moved upward as quickly as possible based on machine mechanical limits (e.g., maximum acceleration until a maximum velocity is reached) in the first step because no material is being cut.

The next step of the operation is to move the tip 112 of the tool 110 along a path 130 (shown with a generic shape) from the waypoint \textcircled{1} at the top of the hole 102 to a waypoint \textcircled{2} at the top of the hole 104. Because the tool 110 is moving through air, this repositioning step can also be performed as quickly as possible (adhering to machine mechanical limits), and the trajectory of the path130 may vary as needed. Techniques for computing a time-optimal trajectory for the path 130 are discussed below. The last step of the operation is to drill the hole 104 by moving the tip 112 of the tool 110 from the waypoint \textcircled{2} at the top of the hole 104 downward along a path 140 to a waypoint \textcircled{3} at the bottom of the hole 104. While drilling the hole 104, the tool 110 cannot be moved faster than a prescribed feed speed, based on the material of the workpiece 100 and other factors, as known in the art.

More than two holes could be drilled in the workpiece 100, in which case the tool path motions discussed above would be repeated successively for each hole. FIG. 1 illustrates a simple two-dimensional tool motion, but motions in the third dimension (“into and out of the page”) may be included, as discussed below. Additionally, FIG. 1 depicts a drilling operation with the tool 110 being a drill bit. It is to be understood that the machine tool motion planning techniques of the present disclosure are equally applicable to other types of machining operations—such as milling with an end mill or a side mill, etc. As such, other types of features (besides holes) could be machined.

Using traditional programming techniques, the multi-hole drilling sequence of FIG. 1 would be programmed and performed as follows: the tool 110 would be positioned at a staging location directly above the hole 102, then lowered to the top of the workpiece 100 where the tool 110 would stop; the hole 102 would then be drilled, which includes accelerating from a standstill to the drilling feed speed, then stopping at the bottom of the hole 102 at waypoint \textcircled{0}; the tool 110 would then move up and out of the hole 102, stopping at waypoint \textcircled{1}; the tool would then be moved in an air cut step along the path 130 (approximately) to the top of the hole 104, where the tool would stop at waypoint \textcircled{2}; the tool would then drill the hole 104, which again includes accelerating from a standstill to the drilling feed speed, then stopping at the bottom of the hole 104 at waypoint \textcircled{3}.

Although the steps described above in the traditional programming method are all available in any machine tool program library, it can be seen that several inefficiencies are present in the motion. In particular, stopping to tool at the waypoints \textcircled{1} and \textcircled{2} adds unnecessary (wasted) time to the machining cycle. At waypoint \textcircled{2}, for example, there is time wasted in decelerating the tool at the end of the air cut step along the path 130, and there is more time wasted in accelerating the tool to the feed speed at the beginning of the drilling step along the path 140. Also, some programming methods require the path 130 to be three separate motions, adding still more time. Following is a discussion of techniques for eliminating the wasted time in multi-step machining operations, which are fundamental principles for the rapid motion primitives of the present disclosure.

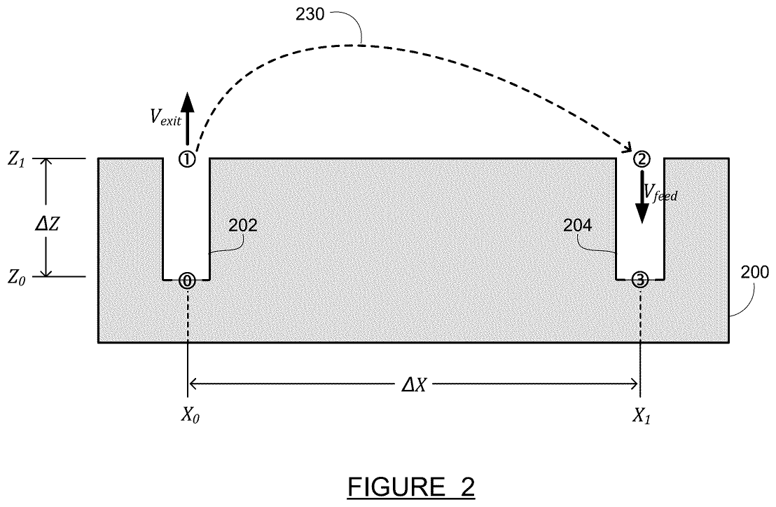

FIG. 2 is a cross-sectional illustration of a workpiece and a machining operation involving two holes as in FIG. 1, and depicting a time-optimal trajectory for moving the tool from the first hole to the second hole. The discussion of FIG. 2 provides an explanation of the computation of the time-optimal trajectory in the absence of any obstacles, including the waypoints and their corresponding state conditions. A workpiece 200 corresponds generally with the workpiece 100 of FIG. 1. In FIG. 2, the machining operation involves drilling or boring two holes, including a hole 202 and a hole 204 using a tool (not shown) equivalent to the tool 110 of FIG. 1. After machining the hole 202, the objective is to reposition the tool as quickly as possible and machine the hole 204. This involves moving the tip of the tool vertically upward out of the hole 202, moving the tip of the tool along a time-optimal trajectory 230, and then machining the hole 204. The waypoints \textcircled{0}, \textcircled{1}, \textcircled{2} and \textcircled{3} have the same definitions as in FIG. 1.

The machine tool or robot performing the machining operation has mechanical constraints and other conditions defined as follows. V_{feed} is the speed in the vertical (z) direction which is used while the tool is cutting material; i.e., machining the hole 204. Vₘₐₓ is the maximum allowable speed/velocity of the tool in either the vertical (z) or horizontal (x) direction while the tool is moving through air; i.e., when repositioning, not machining. Aₘₐₓ is the maximum allowable acceleration of the tool in either the vertical (z) or horizontal (x) direction while the tool is repositioning. A maximum jerk Jₘₐₓ (the rate of change of acceleration) is typically also defined for machine tools.

In order to minimize the cycle time of the machining operation, the following boundary conditions are applied to the steps. In the first step (from \textcircled{0} to \textcircled{1}, the x position is held fixed while the tool is moved upward in the z direction. This upward motion in the first step begins at rest, applies Jₘₐₓ until Aₘₐₓ is reached, and continues at Aₘₐₓ until Vₘₐₓ is reached or until the upward velocity needs to begin being reduced for compatibility with the second step (the trajectory 230). The vertical velocity upon reaching point \textcircled{1} is Vₑₓᵢₜ, which could be less than or equal to Vₘₐₓ depending on the distances ΔZ and ΔX and other factors. The value of Vₑₓᵢₜ and how it relates to the overall time-optimal multi-segment trajectory is discussed later.

As discussed above, the first step in the machining operation is straightforward—upward acceleration to Vₑₓᵢₜ, which is less than or equal to the machine limit velocity Vₘₐₓ. The third step is also very straightforward-constant downward motion at the velocity V_{feed}. The second step is more complicated—with interdependent x and z motions-resulting in the trajectory 230 illustrated in FIG. 2. The motion in the second step is also dependent upon Vₑₓᵢₜ, which creates an interdependence on the motion of the first step. There are several different scenarios for the computation of the tool path motions depicted in FIG. 2. These scenarios depend on the relationships between the distances that need to be traveled (ΔZ and ΔX) and the respective maximum allowable velocities and accelerations (Vₘₐₓ and Aₘₐₓ), in addition to maximum allowable jerk Jₘₐₓ. Following is a discussion of a technique for calculating the time-optimal motion profile for the trajectory 230, along with the implications on the motion profile for the first step of retreating from the hole 202.

In the second step (the trajectory 230 from \textcircled{1} to \textcircled{2}, an x axis (horizontal) “point-to-point” move is performed as fast as possible across the distance ΔX with Vₘₐₓ, Aₘₐₓ and Jₘₐₓ as constraints. The point-to-point move involves a starting velocity of zero (in the x direction in this case), and then includes the following seven phases of jerk-bound motion:
I. apply Jₘₐₓ until Aₘₐₓ is reached
II. continue at Aₘₐₓ until approaching Vₘₐₓ
III. reduce acceleration at −Jₘₐₓ until A=0 is reached at Vₘₐₓ
IV. continue at Vₘₐₓ with no acceleration or jerk
V. apply −Jₘₐₓ to increase negative acceleration until −Aₘₐₓ is reached
VI. continue at −Aₘₐₓ until approaching V=0
VII. apply Jₘₐₓ to reduce negative acceleration until A=0 and V=0 are reached at destination position (waypoint \textcircled{2})

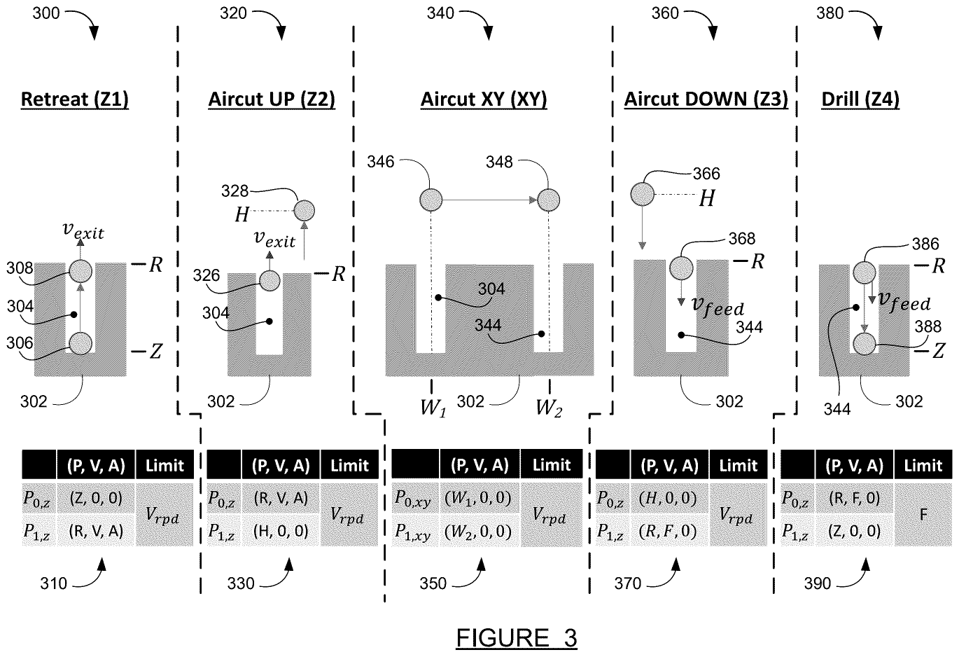

The position, velocity and acceleration for each of the seven phases can be defined using known equations of motion. For example, an equation a₁=a₀+t₁·Jₘₐₓ defines the acceleration at the end of phase I (a₁) as a function of the initial acceleration (a₀), a time duration of phase I (t₁) and the maximum jerk (Jₘₐₓ). Similarly, a velocity at the end of phase I can be defined as a function of the initial velocity, the initial acceleration, the maximum jerk and the time duration of phase I (linearly with acceleration and squared with jerk). Continuing in this manner, the resulting set of polynomials includes 21 equations (seven each for position, velocity and acceleration) and 31 variables (eight for position [p₀-p₇]; eight for velocity [v₀-V₇]; eight for acceleration [d₀-a₇]; and seven for time [t₁-t₇]). Many boundary conditions can be applied to eliminate the excess number of variables relative to equations. For example, in the example described above and shown in FIG. 3, the initial acceleration (d₀) is known to be zero. Also, the final velocity (v₇) is known to be zero, and the final position (p₇) is known to be the distance ΔX.

When all of the boundary conditions are applied as explained above, a system of 21 equations and 21 unknowns remains, which can be solved. This results in values for all of the positions, velocities and accelerations at the beginning and end of each phase, and also the time duration of each phase (that is, the values of t₁-t₇). When the values of time durations of the seven phases are added together (t₁+ . . . +t₇), this reveals the total time of the jerk-bound minimum-time motion profile. For the trajectory 230 of FIG. 2, this total time corresponds to the time duration of the x axis motion from waypoint \textcircled{1}-\textcircled{2}. During this time, the tool completes both an upward and downward axial motion; that is, the z axis velocity is reduced from its upward value at waypoint \textcircled{1} (Vₑₓᵢₜ, which is less than or equal to Vₘₐₓ) to its required downward value at waypoint \textcircled{2} (−V_{feed}). The acceleration required to cause this change in the z axis velocity is readily calculable given the time duration calculated from the x axis motion.

Still referring to FIG. 2—in the third step (from \textcircled{2} to \textcircled{3}), the x position is held fixed while the tool is moved downward in the z direction at the speed of −V_{feed} to machine the hole 204. Note that at the end of the second step (the trajectory 230), the velocity in the x direction is required to be zero, and the velocity in the z direction is required to be −V_{feed}. These boundary conditions are enforced during the optimization of the waypoint states in the multi-segment trajectory. This optimization is discussed below.

Table 1 below summarizes the states which are specified at each of the waypoints \textcircled{0}, \textcircled{1}, \textcircled{2} and \textcircled{3} for the 3-step machining operation (retreat, move, drill) depicted in FIG. 2 and described above. For each waypoint, the x axis and z axis position and velocity which must be met are defined in the table. The only unknown value in Table 1 is the vertical velocity at waypoint \textcircled{1} (Vₑₓᵢₜ). The value of Vₑₓᵢₜ will be determined in a manner discussed below.

TABLE 1

| | | | Step 2 | | | | | |
|---|---|---|---|---|---|---|---|---|
| | Step 1 | | | | Step 3 | | | |
| | Waypoint | | | | | | | |
| | \textcircled{0} | | \textcircled{1} | | \textcircled{2} | | \textcircled{3} | |
| State | pos. | vel. | pos. | vel. | pos. | vel. | pos. | vel. |
| x axis | X₀ | 0 | X₀ | 0 | X₁ | 0 | X₁ | 0 |
| z axis | Z₀ | 0 | Z₁ | Vₑₓᵢₜ | Z₁ | −V_{feed} | Z₀ | 0 |

As mentioned above and shown in Table 1, the only unknown waypoint state for the 3-step motion of FIG. 2 is the vertical velocity at waypoint \textcircled{1} (Vₑₓᵢₜ). Intuitively, it may seem that Vₑₓᵢₜ should always be equal to Vₘₐₓ. However, this is often not the case. For example, if the height (ΔZ) of the hole 202 is very small, a maximum acceleration motion will not reach a velocity of Vₘₐₓ. A more interesting case arises when the exit velocity Vₑₓᵢₜ affects the time required to traverse the trajectory 230 of step 2. This type of interdependency means that a truly time-optimal trajectory for a multi-segment motion can only be computed by calculating the motions of all of the segments and optimizing the states of the intermediate waypoints to minimize overall time. The motion primitives of the present disclosure are defined in a manner which allows corresponding programming language software to perform this intermediate state optimization.

Still referring to FIG. 2, consider a geometry where the hole 202 is deep and the distance ΔX is short. In this case, if the exit velocity Vₑₓᵢₜ is equal to Vₘₐₓ, the vertical deceleration in step 2 (from waypoint \textcircled{1}-\textcircled{2}) will take more time than the horizontal translation of step 2. This means that step 2 could be completed more quickly if, at the end of step 2, the exit velocity Vₑₓᵢₜ is less than Vₘₐₓ. This in turn means that the motion of step 1 is no longer a simple case of acceleration to Vₘₐₓ, but rather is a vertical acceleration, leveling off of velocity at or below Vₘₐₓ, and then a deceleration to an exit velocity of Vₑₓᵢₜ. This then becomes another example of the seven-phase jerk-bound motion profile described above. Furthermore, the exit velocity Vₑₓᵢₜ is now an unknown state for both step 1 and the vertical calculation portion of step 2.

The example described above illustrates that the time-optimal trajectory depends on the relative values of the geometry properties (ΔX and ΔZ) and their relationship with the mechanical limits of the machine tool (Vₘₐₓ, Aₘₐₓ and Jₘₐₓ), and in general can only be determined by simultaneously calculating all steps of the multi-step motion—in both the vertical and lateral directions—and optimizing the boundary states of the common waypoints. This calculation includes possible variations in start timing of vertical and lateral motions in step 2.

Techniques for performing all of these time-optimal trajectory computations for different geometric scenarios-both with and without collision avoidance considerations along the air cut trajectory segments-were disclosed in U.S. patent application Ser. No. 18/491,147 (hereinafter “the '147 application”), titled MACHINE PROGRAMMING METHOD, filed Oct. 20, 2023 and commonly assigned with the instant application, and hereby incorporated by reference.

The complexities and interdependencies of trajectory calculation, even for simple cases like the example shown in FIG. 2, have traditionally been overlooked in real world machining operations. This is because conventional multi-step motion planning for machine tools (such as 3-axis mills and articulated robots) uses motion program codes which require the tool to stop between steps. This approach (stopping between steps) is a very simple solution from a programming standpoint, but it adds time to the completion of the multi-step machining operation.

The present disclosure provides a set of motion primitives which may be employed in machining operations such as depicted in FIGS. 1 and 2, where the motion primitives enable calculation of a motion program with continuous tool motion from one step to the next, thereby eliminating the wasted acceleration/deceleration time from the machining cycle. The motion primitives are used instead of traditional programming commands (which stop at the end of each motion) in a machining program. The machining program defines a multi-step machining operation using the motion primitives, and the programming language computes a time-optimal tool motion including a non-static transition from each step to the next, and the computed tool motion (trajectory) is used by the machine tool. This is discussed in detail below.

FIG. 3 is an illustration of a set of motion primitives which may be used in combinations to program a multi-step machining operation on a machine tool, where a programming language computes a time-optimal tool motion from the motion primitives including non-static transitions between steps, according to embodiments of the present disclosure.

FIG. 3 depicts five motion primitives which are the foundation for multi-step machining operations for a drilling or boring machine, according to the disclosed techniques. The motion primitives may be combined to perform a continuous sequence of drilling or boring operations, and to perform other specialized machining operations. The application of the motion primitives to perform multi-step machining operations is discussed later, after the description of the motion primitives themselves. All of the motion primitives are described in terms of motion in either a vertical direction (i.e., “Z” direction, parallel to a spindle axis of the machine tool) or a lateral direction (i.e., “X-Y” direction, perpendicular to the spindle axis of the machine tool). In FIG. 3, the circles indicate the tip of the tool at the beginning and end of each motion primitive, where the beginning point is identified as P₀ and the ending point is identified as P₁.

A Retreat motion primitive is shown at 300. Retreat is a motion primitive used in a machining program to cause the machine tool to be extracted from a previously-drilled hole. A workpiece 302 contains a previously-drilled hole 304. The Retreat motion primitive causes the tool tip to move from a point 306 (P₀) at the bottom of the hole 304 to a point 308 (P₁) at the top of the hole 304. When reaching the point 308 (P₁) at the top of the hole 304, the tool will have an upward velocity of Vₑₓᵢₜ, the calculation of which is discussed below. The bottom of the hole 304 has a vertical coordinate identified as Z, and the top of the hole 304 (P₀) has a vertical coordinate identified as R (P₁).

A table 310 corresponds with the Retreat motion primitive shown at 300. The table 310 depicts the data which defines the Retreat motion primitive. Because the Retreat motion primitive defines a vertical (i.e., Z-axis) motion, the rows in the table 310 are labeled P_{0,z} and P_{1,z}, which means they represent the Z-axis motions at points P₀ and P₁, respectively. The middle column of the table 310 indicates that the motions described are a position (P), a velocity (V) and an acceleration (A) at each of the points. For the Retreat motion primitive, Z-direction position at point P₀ is Z (the bottom of the hole), and the Z-direction velocity and acceleration at point P₀ are zero. The Z-direction position at point P₁ is R (the top of the hole), the Z-direction velocity at point P₁ is identified as V, and the Z-direction acceleration at point P₁ is identified as A. The values of V and A are variables which are not assigned values by the user when writing the machining program. Instead, the values of V and A will be calculated by the programming language software when the tool motion is computed for the entire multi-step machining operation. It will be recognized that the value of V at point P₁ is the exit velocity Vₑₓᵢₜ mentioned earlier. Throughout the remainder of the present disclosure, velocity states such as Vₑₓᵢₜ and V_{feed} are discussed extensively as they pertain to the tool motions at the end of one motion primitive step and the beginning of the next. It is also to be understood that acceleration boundary condition states many also be non-zero at some intermediate points; for example, when reaching the point P₁ at the end of the Retreat motion primitive (at the top of the hole 304), the tool may still be accelerating in the Z direction, or in the case of a very deep hole the tool may be decelerating when it reaches the top of the hole.

The right-hand column of the table 310 indicates what velocity limit is in effect during the Retreat motion primitive. In this case, the velocity limit is identified as V_{rpd} (rapid velocity), which is the maximum allowable velocity in the Z-direction according to machine mechanical limits. Other machine mechanical limits are also in effect as would be understood by those skilled in the art. That is, when accelerating from a standstill up to V_{rpd}, the machine motion is constrained by the machine's maximum acceleration (Aₘₐₓ) and maximum jerk (Jₘₐₓ), as discussed earlier and in the '147 application.

To summarize, in order to add a command to a machining program for exiting a hole, the user simply selects the Retreat motion primitive and defines the vertical coordinates Z and R; the rest of the parameters describing the motion step are known (zero velocity and acceleration at point P₀) or will be calculated in connection with the other motion primitives (velocity and acceleration at point P₁) when the programming software resolves the entire multi-step machining operation. In fact, when multiple motion primitives are used in sequence in a machining program, even the values of Z and possibly R will already be known from the previous drilling step.

An Aircut-Up motion primitive is shown at 320. Aircut-Up is a motion primitive used in a machining program to cause the machine tool to continue moving upward after being extracted from a previously-drilled hole. The workpiece 302 contains the previously-drilled hole 304 as discussed earlier. The Aircut-Up motion primitive causes the tool tip to move from a point 326 (P₀) at the top of the hole 304 to a point 328 (P₁) at a height H which is to be determined during calculation of the motion plan and trajectory. At the point 326 (P₀) at the top of the hole 304, the tool will have the upward velocity of Vₑₓᵢₜ from the previous Retreat step, the calculation of which is discussed below. The point 328 (P₁) is shown laterally offset from the point 326 (P₀) because lateral motion may also be occurring during the Aircut-Up motion. To be clear, the Aircut-Up motion primitive only defines vertical motion. Overlapping motion with a lateral motion primitive is discussed extensively below.

A table 330 corresponds with the Aircut-Up motion primitive shown at 320. For the Aircut-Up motion primitive when following a Retreat motion primitive, the Z-direction position at point P₀ is R (the top of the hole), the Z-direction velocity at point P₀ is V, and the Z-direction acceleration at point P₀ is A. V and A are variables which are not assigned numerical values by the user when writing the machining program. Instead, the values of V and A will be calculated (to match the Retreat step and minimize overall cycle time) by the programming language software when the tool motion is computed for the entire multi-step machining operation. It will be recognized that the value of V at point P₀ is the exit velocity Vₑₓᵢₜ mentioned earlier. The Z-direction position at point P₁ is H (an unknown until trajectory calculation), while the Z-direction velocity and the Z-direction acceleration at point P₁ are zero. During the Aircut-Up motion primitive, the velocity limit is V_{rpd}, the same maximum machine velocity described earlier.

To summarize, in order to add a command to a machining program for air cutting upward after exiting a hole, the user simply selects the Aircut-Up motion primitive; all of the parameters describing the Aircut-Up motion step are known (position R at point P₀, and zero velocity and acceleration at point P₁) or will be calculated in connection with the other motion primitives (velocity and acceleration at point P₀, and the height H at point P₁) when the programming software resolves the entire multi-step machining operation.

An Aircut-XY motion primitive is shown at 340. Aircut-XY is a motion primitive used in a machining program to cause the machine tool to move laterally (i.e., in the X and/or Y directions) from one hole location to the next. The workpiece 302 contains the previously-drilled hole 304 as discussed earlier, and another hole 344. The Aircut-XY motion primitive causes the tool tip to move laterally from a point 346 (P₀) at the X-Y location of the hole 304 (identified as W₁) to a point 348 (P₁) at the X-Y location of the hole 344 (identified as W₂).

Aircut-XY is the only motion primitive which defines lateral motion. The lateral motion of the motion primitive Aircut-XY may (and typically will) take place concurrently with vertical motions. Specifically, the lateral motion of the Aircut-XY motion primitive may begin at the same time as the preceding Aircut-Up begins (because the tool tip is clear of the top of the workpiece 302), and the lateral motion of the Aircut-XY motion primitive may continue until the following Aircut-Down is complete (because the tool tip is about to contact the top of the workpiece 302).

A table 350 corresponds with the Aircut-XY motion primitive shown at 340. The Aircut-XY motion primitive has a lateral position W₁ at point P₀ (which may be defined in X- and Y-coordinates), and a lateral position W₂ at point P₁. When following a Retreat and Aircut-Up motion primitive, the lateral position W₁ at point P₀ will be known (from the previously drilled hole); the lateral position W₂ at point P₁ (the location of the next hole) must be entered by the user when defining the Aircut-XY motion primitive. During the Aircut-XY motion primitive, the velocity limit is V_{rpd}, the same maximum machine velocity described earlier (if the machine tool has a different maximum velocity in the lateral direction than in the vertical/axial direction, then the lateral maximum velocity is used for the Aircut-XY motion primitive).

As mentioned above, the lateral motion of the Aircut-XY motion primitive is normally concurrent with the upward motion of the preceding Aircut-Up motion primitive and the downward motion of the following Aircut-Down motion primitive. The interdependencies of these motions were mentioned earlier, and the associated calculations were described in detail in the '147 application. To summarize these interdependencies: if the lateral distance from W₁ to W₂ is large, then the time required to move laterally will dictate the overall timing of the Aircut-Up, Aircut-XY and Aircut-Down steps, which means that the exit velocity Vₑₓᵢₜ and the height H can be larger without adversely affecting overall machining cycle time. However, if the lateral distance from W₁ to W₂ is small, then the time required to perform the Aircut-Up and Aircut-Down steps will dictate the overall timing, which means that smaller values of the exit velocity Vₑₓᵢₜ and the height H will result in a shorter overall machining cycle time. All of these interdependencies are resolved during calculation of the complete machine tool trajectory based on all of the motion primitives used in the machining program.

To summarize, in order to add a command to a machining program for air cutting laterally from one hole to the next, the user simply selects the Aircut-XY motion primitive and defines the X-Y location of the second hole. When an Aircut-XY motion primitive follows an Aircut-Up motion primitive and precedes an Aircut-Down motion primitive, the programming language software knows that these three motions can be performed concurrently when computing the entire multi-step machining operation.

An Aircut-Down motion primitive is shown at 360. Aircut-Down is a motion primitive used in a machining program to cause the machine tool to begin moving downward in preparation for drilling a next hole. The workpiece 302 has a location for the next hole 344 as discussed earlier; the hole 344 is shown as if it were already drilled, but this is just for illustration purposes; the hole 344 has not yet been drilled. The Aircut-Down motion primitive causes the tool tip to move from a point 366 (P₀) at the height H (from the Aircut-Up step, with a value to be determined during trajectory calculation) to a point 368 (P₁) at the top of the hole 344. The point 368 (P₁) is shown laterally offset from the point 366 (P₀) because lateral motion will typically also be occurring during the Aircut-Down motion as discussed above. To be clear, the Aircut-Down motion primitive only defines vertical motion.

A table 370 corresponds with the Aircut-Down motion primitive shown at 360. For the Aircut-Down motion primitive when following Aircut-Up and Aircut-XY motion primitives, the Z-direction position at point P₀ is H (from the previous Aircut-Up; unknown to the user, and calculated during overall trajectory computation), and the Z-direction velocity and acceleration at P₀ are zero. The Z-direction position at point P₁ is R (the top of the hole 344, which could be the same height as the top of the hole 304, or could be different), the Z-direction velocity at point P₁ is a feed speed (V_{feed}) for a subsequent drilling step (shown as F in the table 370) and the Z-direction acceleration at point P₁ is zero. In other words, the Aircut-Down step ends with the tool moving at the correct drilling feed speed just as the tool tip reaches the surface of the workpiece 302. During the Aircut-Down motion primitive, the velocity limit is V_{rpd}, the same maximum machine velocity described earlier.

To summarize, in order to add a command to a machining program for air cutting downward before drilling a hole, the user simply selects the Aircut-Down motion primitive, defines the height value R (which may be the same as for a previously-exited hole), and enters the feed speed F if its value has not already been defined in the machining program; all of the other parameters describing the Aircut-Down motion step are known (the zero velocity and acceleration values) or will be calculated in connection with the other motion primitives (the height H at point P₀) when the programming software resolves the entire multi-step machining operation. If an Aircut-Down motion primitive does not follow an Aircut-Up motion primitive, then a value of the height H at point P₁ must be defined in the machining program.

A Drill motion primitive is shown at 380. Drill is a motion primitive used in a machining program to cause the machine tool to drill a hole. The Drill motion primitive is the only motion primitive which does not define an air cut step. When the Drill motion primitive is used after the Aircut-Down motion primitive in a machining program, the programming software will calculate the overall machining cycle trajectory so that there is no tool stoppage between the Aircut-Down step and the Drill step. The workpiece 302 includes the next hole 344 as discussed earlier; the hole 344 is being drilled by the Drill motion primitive. The Drill motion primitive causes the tool tip to move from a point 386 (P₀) at the top of the hole 344 to a point 388 (P₁) at the bottom of the hole 344. The spindle is turning at the appropriate speed for drilling, and the tool is moved vertically at the feed speed V_{feed} (a.k.a., F) during the Drill step.

A table 390 corresponds with the Drill motion primitive shown at 380. The Z-direction position at point P₀ is R (the top of the hole 344, at the top surface of the workpiece 302), the Z-direction velocity at P₀ is-V feed (the feed speed F in the downward direction), and the Z-direction acceleration at P₀ is zero. The Z-direction position at point P₁ is Z (the bottom of the hole 344, which could be the same height as the bottom of the previous hole 304, or could be different), the Z-direction velocity at point P₁ is zero and the Z-direction acceleration at point P₁ is zero. In other words, the Drill step has a constant feed speed F which is reduced to zero as it reaches the bottom of the hole.

To summarize, in order to add a command to a machining program for drilling a hole, the user simply selects the Drill motion primitive, defines the height values R and Z if different than the previously-exited hole, and enters the feed speed F if its value has not already been defined in the machining program; all of the other parameters describing the Drill step are known.

A key advantage of the motion primitives depicted in FIG. 3 is that they can be combined to create a motion program where the tool does not stop between steps. This is depicted in later figures and discussed below. The values of the non-static boundary conditions between steps (e.g., Vₑₓᵢₜ and H) are calculated by the programming language software when computing a time-optimal trajectory for the entire machining cycle. Furthermore, when axial and lateral air cut steps are defined in sequential motion primitives, the programming language software can combine these motions to happen concurrently in a manner which reduces the overall machining operation cycle time considerably.

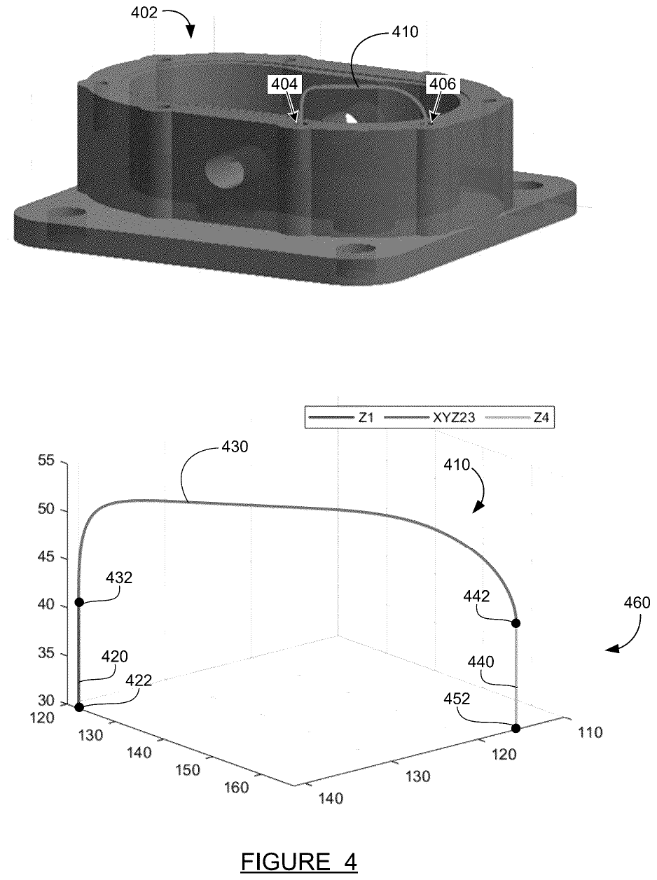

FIG. 4 is an illustration of a multi-step machining operation performed using the motion primitives in a machining program according to embodiments of the present disclosure, along with a corresponding graph of the tool trajectory in workspace coordinates showing how the motion primitives are represented in the tool motion. FIG. 4 illustrates a primary application of the motion primitives from FIG. 3; that is, drilling multiple holes in a workpiece.

A workpiece 402 is shown at the top of FIG. 4. The workpiece 402 is depicted with several holes, and a tool path trajectory 410 exiting a hole 404 and entering a hole 406. The tool path trajectory was computed, by the programming language of the present disclosure, from a machining program including a Drill motion primitive to drill the hole 404, followed by a Retreat motion primitive, an Aircut-Up motion primitive, an Aircut-XY motion primitive, an Aircut-Down motion primitive, and finally a Drill motion primitive to drill the hole 406.

The trajectory 410, which traces the path of the tool tip, is depicted again in a graph 460 of the three-dimensional workspace where the machining operation is being performed. The trajectory 410 consists of a first section 420 extending from a point 422 vertically upward to a point 432, a second section 430 extending from the point 432 (upward, across and down) to a point 442, and a third section 440 extending vertically downward from the point 442 to a point 452. The point 422 represents the bottom of the hole 404; the point 432 represents the top of the hole 404; the point 442 represents the top of the hole 406; and the point 452 represents the bottom of the hole 406.

The trajectory 410 was computed by programming language software based on a machining program containing the following lines:

[ . . . drilling of the hole 404, such as with a Drill motion primitive . . . not shown]. Retreat motion primitive to top of the hole 404 (R); V and A are variables not defined in machining program (computed later); limit of V_{rpd}
Aircut-Up motion primitive; H, V and A are variables not defined in machining program; limit of V_{rpd}
Aircut-XY motion primitive; W₁ is previously-defined X-Y location of the hole 404; W₂ is defined as the X-Y location of the hole 406; limit of V_{rpd}.
Aircut-Down motion primitive to top of the hole 406 (R); ending at feed speed F; H is a variable not defined in machining program; limit of V_{rpd}.
Drill motion primitive to bottom of the hole 406 (Z) at feed speed F
   [ . . . then another sequence of motion primitives to retreat, move and drill the next hole . . . ]

First, it is apparent from the listing above that very little parameter data needs to be entered for each motion primitive in the machining program. For example, considering that the machine maximum velocity is a known value for a particular machine and machining program, the Retreat motion primitive only requires the height value R (top of hole) to be defined; the Aircut-Up motion primitive actually requires no parameters to be entered; and so forth.

In addition, the programming language software combines the Aircut-Up, Aircut-XY and Aircut-Down motion primitives to be performed concurrently, as discussed earlier. The second section 430 of the trajectory 410 is the combined motion of the Aircut-Up, Aircut-XY and Aircut-Down motion primitives. The programming language software knows that these three motions can be performed concurrently when they appear in sequence in a machining program, and multi-step machining operation is computed accordingly.

The variable parameters H, V and A (all appearing in the Aircut-Up motion primitive and involved in a preceding or following motion primitive) are computed by the programming language software in the manner described earlier. That is, a time-optimal trajectory for the entire five-step machining operation is computed. The five steps which are combined begin and end with the tool at a standstill (at the bottom of the drilled holes); all motions in between those two static points are continuous with no tool stoppage. The variable parameters (H, V and A) are computed to provide the shortest total trajectory time based on the machine's maximum velocity (V_{rpd}), the machine's maximum acceleration (Aₘₐₓ) and maximum jerk (max), and the geometric relationships of the machining operation (e.g., height from Z to R, and lateral distance from W₁ to W₂). These calculations and the various implications on the exit velocity Vₑₓᵢₜ (V) and the height H were discussed in detail in the '147 application.

To summarize, the five-step machining operation depicted in FIG. 4 exemplifies the following advantages of the disclosed motion primitives and associated programming language software: simplified/reduced parameter data entry for program command lines; combination of Aircut-Up, Aircut-XY and Aircut-Down steps performed concurrently; no stopping of the tool for the entire machining operation from the bottom of one drilled hole to the bottom of the next drilled hole; and computation of a time-optimal tool motion trajectory for the entire machining operation with variable parameter values optimized based on the geometric relationships and the machine speed limit.

It is emphasized that the benefits listed above can only be realized with the disclosed motion primitives and associated programming language software. Traditional machining program techniques only allow one-step-at-a-time commands, and the tool stops after each step. Even if the tool were allowed to continue from one step to the next (such as after retreating from a hole and continuing to air cut up), the programmer of a traditional system would need to guess at the exit velocity and enter that value in the command line; there is no way to accurately guess the value of Vₑₓᵢₜ because of the complex interactions with the other steps in the machining operation.

Besides the machining operation depicted in FIG. 4 for drilling multiple holes in succession, the motion primitives of the present disclosure can be combined in other ways. These combinations-shown in the following figures and discussed below-allow certain other machining operations to be performed in a time-optimal manner, while also simplifying the programming command line data entry.

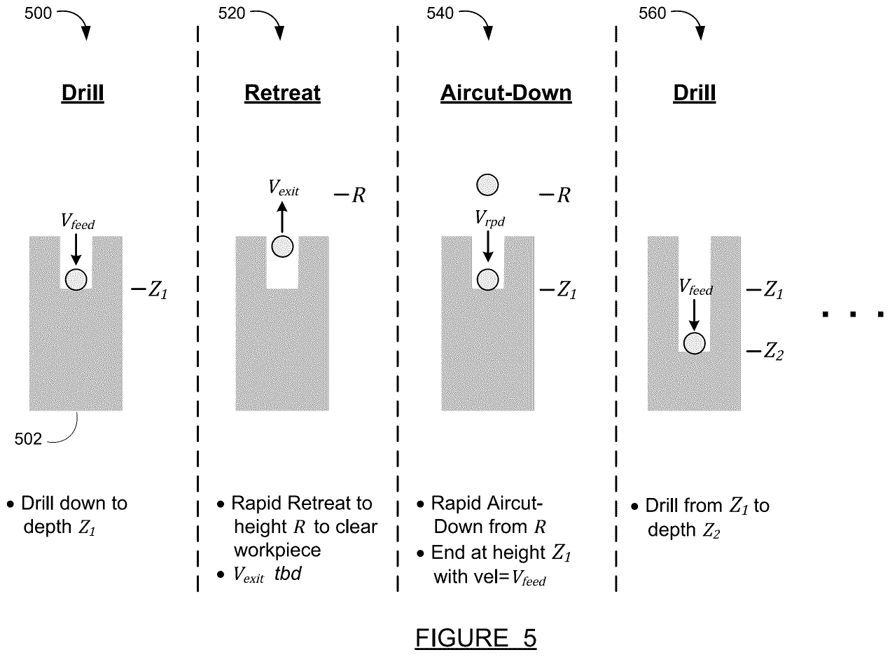

FIG. 5 is an illustration of a sequence of some of the motion primitives of FIG. 3 which may be used for a pecking-type drilling operation, where the pecking operation drills a hole in stages of increasing depth, and the programming language computes a time-optimal tool motion from the motion primitives including non-static transitions between steps, according to embodiments of the present disclosure.

“Pecking” is a term used to describe drilling a hole in a sequence of steps, each step being drilled to an increasing depth. For example, a hole which is required to be 20 mm deep could be first drilled to 5 mm depth, then the tool (e.g., drill bit) extracted from the hole to allow the chips produced during drilling to clear the hole. This would be followed by drilling the hole to 10 mm deep, extracting the tool, drilling to 15 mm deep, extracting the tool, and finally drilling the hole to 20 mm deep. In addition to clearing machining chips from the hole, pecking also allows heat to dissipate from the workpiece and the tool between drilling steps.

In a first step indicated at 500, the Drill motion primitive is used to drill from the top surface of the workpiece down to a first hole depth Z₁. In a second step indicated at 520, the Retreat motion primitive is used to extract the tool from the hole. The Retreat motion primitive designates the point P₁ (see FIG. 3) as being at a height R, which is some height above the top surface of the workpiece to allow the chips to clear. The tool will exit the hole with a velocity V (Vₑₓᵢₜ, unknown/undefined in the machining program, to be calculated by the programming language software) and continue upward to the height R.

In a third step indicated at 540, the Aircut-Down motion primitive is used to rapidly move the tool back down into the hole. The Aircut-Down motion primitive uses a maximum velocity profile for as long as possible (to be calculated) with the constraint that the tool must reach the height Z₁ at the drilling feed speed V_{feed}. With no stopping between steps, a Drill motion primitive is then used (indicated at 560) to drill from the height Z₁ to the height Z₂. This sequence of three steps (using the Retreat, Aircut-Down, and Drill motion primitives) can then be repeated as many times as necessary to reach the final hole depth, with each drilling step having a prescribed decrement of height.

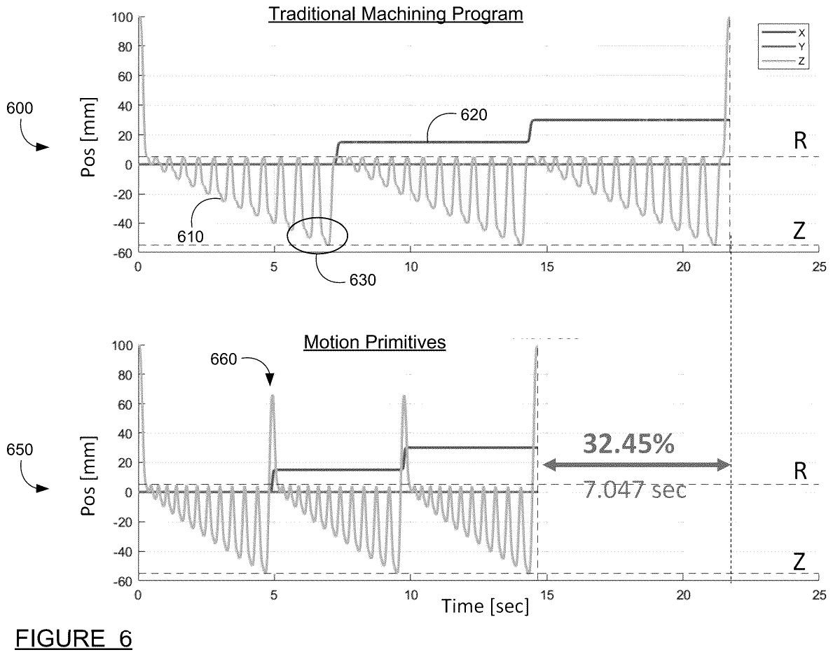

FIG. 6 includes a graph of position versus time for a pecking operation using traditional machining program methods, and a graph of position versus time for the pecking operation using the sequence of motion primitives illustrated in FIG. 5 according to embodiments of the present disclosure.

A graph 600 shows the position of the tool for a set of three holes drilled in a workpiece using a multi-stage pecking sequence defined with traditional machining program commands. A trace 610 plots the vertical (Z) motion of the tool, where the increased hole depth at each next step of each sequence is clearly visible. A trace 620 plots the lateral (X) motion of the tool, where it is apparent that the tool moves to a next hole at about 7 seconds and again moves to a next hole at about 14 seconds into the operation.

A graph 650 shows the position of the tool for the same set of three holes drilled in a workpiece using a multi-stage pecking sequence defined with the motion primitives of the present disclosure and as depicted in FIG. 5. The convention for the X position and Z position data traces is the same as in the graph 600. It is immediately clear that the set of three pecking operations using the motion primitives is completed much more quickly than with traditional machining program commands. In the experimental evaluation which produced the data on these graphs, the motion primitive-based technique produced a tool motion program which completed the operations with a reduction of time of over 32% as compared to the traditional methods. One key reason for the cycle time improvement using the motion primitives is that the tool does not stop in between the Aircut-Down motion primitive and the Drill motion primitive. In contrast, using traditional machining program techniques, the tool stops at the bottom of each air cut down step, and then has to accelerate to the feed speed at the beginning of each drilling step. This hesitation can be seen at the bottom of each step as indicated in ellipse 630, whereas the motion primitive-based technique in the graph 650 includes no such hesitation.

Again, this improvement in cycle time is made possible by using a programming language which allows motion primitives to be defined with non-static boundary conditions between steps, where the time-optimal motion profile for the entire machining operation is computed by the programming language software using the techniques described earlier and disclosed in detail in the '147 application.

Another noticeable difference between the graphs 600 and 650 is at the transition from one hole to the next. The traditional machining program technique in the graph 600 shows that, when the tool is moved in the X direction at about 7 seconds, the Z position of the tool is simply at R, the height slightly above the top surface of the workpiece, as this is how traditional machining program commands would be defined. In contrast, at a hole transition as indicated at 660, the motion primitive-based technique includes an Aircut-Up, Aircut-XY and Aircut-Down set of motion primitives which allow a significant overshoot (to a height H as defined in FIG. 3) in the Z direction which happens concurrently with the X axis move. This difference in Z axis motion at the hole transitions does not have much effect on cycle time, but it illustrates how the motion primitives are used in a machining program and how the programming language software automatically calculates the most time-optimal overall motion profile.

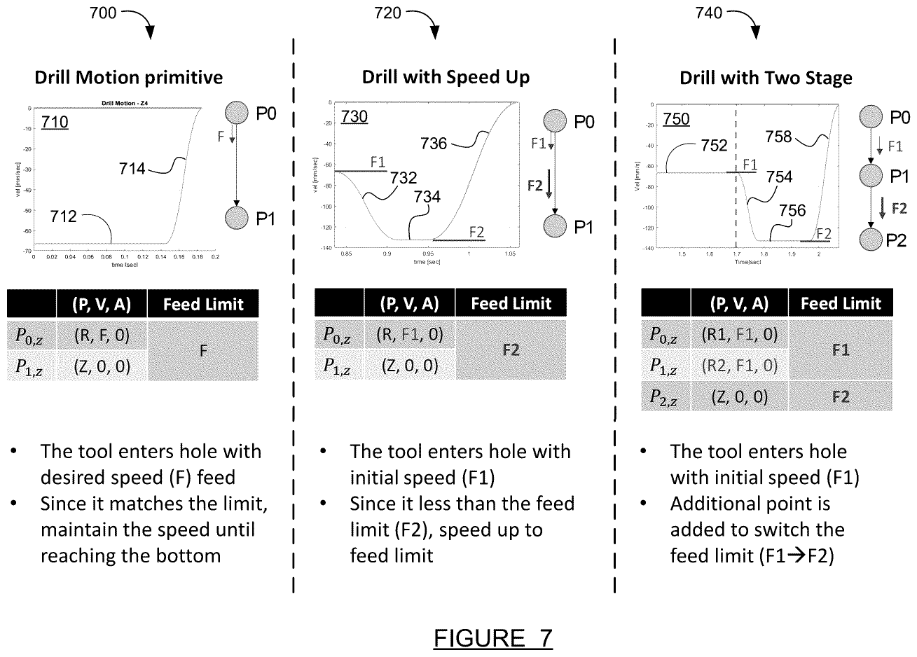

FIG. 7 is an illustration of three variations of the Drill motion primitive, including constant speed drilling as discussed in connection with FIG. 3, and two different types of speed change during drilling, according to embodiments of the present disclosure.

Illustrated at 700 is the Drill motion primitive as shown in FIG. 3 and discussed earlier, where the tool enters the hole at the desired speed F (i.e., the feed speed Vreed) and maintains the constant feed speed until nearing the bottom of the hole where the speed is decelerated to zero. A graph 710 depicts the tool velocity profile versus time for the standard Drill motion primitive. On all of the graphs of FIG. 7, the vertical axis is velocity, with a velocity of zero at the top of the graph and increasing negative velocities (indicating drilling downward, in the negative Z direction) going down the vertical axis. On the graph 710, a portion 712 of the trace indicates where the tool maintains the constant speed F from the beginning of the drill step (at the left) until near the end (defined by the point P₁ at the bottom of the hole), and a portion 714 of the trace indicates where the tool rapidly decelerates from the speed F (which is a negative velocity, i.e., downward) to zero velocity at the end of the drill step. As is the case with many of the velocity and acceleration profiles involved in the motion primitives, the calculation of the deceleration at the bottom of the hole (the portion 714) is performed using the principles of the seven-phase jerk-bound solution technique discussed earlier and explained in detail in the '147 application.

Illustrated at 720 is a Drill motion primitive where the tool enters the hole at an initial speed F1 which is less than the desired drilling speed F2. The tool speeds up as soon as it begins drilling until it reaches the desired drilling speed F2 and maintains constant speed at F2 until nearing the bottom of the hole where the speed is decelerated to zero. The drill with speed-up scenario illustrated at 720 could happen in any situation where the tool does not have enough time and space after a previous operation to reach the desired feed speed before drilling commences. A graph 730 depicts the tool velocity profile versus time for the Drill motion primitive with speed-up on entering the hole. On the graph 730, a portion 732 of the trace indicates where the tool accelerates from the initial speed F1 at the beginning of the drill step (at the left) until reaching the desired drilling speed F2, a portion 734 of the trace indicates where the tool maintains the constant speed F2 as long as possible, and a portion 736 of the trace indicates where the tool rapidly decelerates from the speed F2 to zero velocity at the end of the drill step.

Illustrated at 740 is a two-stage drilling operation where two of the Drill motion primitives are used, where the tool enters the hole at an initial drilling feed speed F1 and drills at this speed until reaching point P1, where the tool speeds up to a second drilling feed speed F2. The tool maintains constant speed at F2 until nearing the bottom of the hole (point P2) where the speed is decelerated to zero. The two-stage drill scenario illustrated at 740 could happen in a situation where a greater feed speed is permissible below a certain hole depth because the greater hole depth provides stability to a slender drilling tool, for example. A graph 750 depicts the tool velocity profile versus time for the two-stage drilling (using two of the Drill motion primitives). On the graph 750, a portion 752 of the trace indicates where the tool maintains the feed speed F1 of the first Drill motion primitive. Upon reaching the point P1 (the end of the first Drill motion primitive, indicated at the time marked by the dashed vertical line), the tool accelerates as depicted in a portion 754 until reaching the desired drilling speed F2 of the second Drill motion primitive. A portion 756 of the trace indicates where the tool maintains the constant speed F2 as long as possible, and a portion 758 of the trace indicates where the tool rapidly decelerates from the speed F2 to zero velocity at the end of the second drill step.

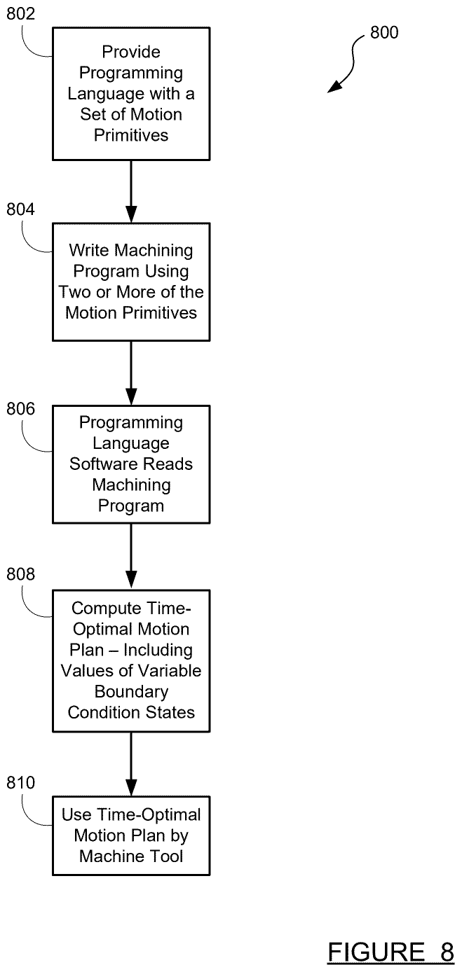

FIG. 8 is a flowchart diagram 800 of a method for motion programming of a machine tool, where a programming language includes motion primitives which are used in sequence in a machining program, and a programming language software application computes a time-optimal motion plan from the machining program, according to embodiments of the present disclosure.

At box 802, a programming language is provided including a set of motion primitives as illustrated on FIG. 3. In a preferred embodiment, the set of motion primitives includes a Retreat motion primitive, an Aircut-Up motion primitive, an Aircut-XY motion primitive, an Aircut-Down motion primitive and a Drill motion primitive. All of the motion primitives define a motion in an axial tool direction except the Aircut-XY motion primitive which defines motion in a lateral direction. All of the motion primitives define air cut motions except the Drill motion primitive which defines a cutting step. Each motion primitive is defined in terms of a first and second point, with position and velocity states at each of the points. Some of the states may be defined as variable rather than having a fixed value, in which case they are solved for by the programming language software to provide a time-optimal motion program. Acceleration states may also be defined, which may also be variable. Each motion primitive has a corresponding limit velocity, either the maximum machine velocity or a feed speed, and each motion primitive is also constrained by all machine mechanical limits (maximum velocity, acceleration and jerk).

At box 804, a machining program is written for a machining operation, including two or more of the motion primitives in the machining program. The machining program may be written by a human user, or created automatically by software such as a Computer Aided Manufacturing (CAM) system. The motion primitives in the machining program include at least one air cut step and one cutting step. The position and velocity states at the first point of one motion primitive are defined to match the states at the second point of a preceding motion primitive. For example, a Drill motion primitive has a first point with a position at the top surface of the workpiece and a velocity of the feed speed F, and the preceding Aircut-Down motion primitive has the same position and velocity for its second point. Similarly, the first point of an Aircut-Up motion primitive has a velocity V (Vₑₓᵢₜ), and the preceding Retreat motion primitive has the same velocity for its second point; in this case, the velocity V is a variable to be calculated by the programming language software, as discussed at length earlier.

At box 806, the machining program is read by the programming language software. At box 808, a motion plan for the machining operation is computed by the programming language software. The motion plan defines a complete trajectory of the tool for the entire machining operation-including a time-based definition of all positions, velocities and accelerations. This includes calculating the velocity profile for all steps of the motion plan, and values of all variable states (such as Vₑₓᵢₜ and H, as discussed earlier) which result in a minimum total time for the steps defined by the motion primitives. It also includes performing the lateral motion of an Aircut-XY motion primitive concurrently with the axial motions of Aircut-Up and Aircut-Down motion primitives. The resulting motion plan for drilling one hole after another at different locations is as depicted on FIG. 4, the motion plan for a pecking-type drilling operation is as depicted on FIGS. 5 and 6, and the motion plan for drilling with speed changes operation is as depicted on FIG. 7, all of which were described in detail earlier.

The computation of the motion plan at the box 808 is performed using the iterative calculation techniques discussed above in the present disclosure, and discussed in additional detail in the '147 application. That is, the velocity profiles for each step of the motion plan (e.g., drill, retreat, air cut up, air cut laterally, etc.) are computed in the axial and lateral directions using the seven-phase jerk-bound motion profile calculations based on the machine's mechanical limits; values of variable boundary condition states (such as Vₑₓᵢₜ and H) are varied and the velocity profiles are recalculated. Each complete motion plan results in a total cycle time for the multi-step operation, and the motion plan calculation is repeated iteratively until a minimum total cycle time is found. Each iteration of the motion plan calculation uses different values of the variable boundary condition states and different velocity profiles, and a supervisory algorithm is used to identify parameter values which yield the minimum total cycle time. Any suitable technique may be used to supervise the iterative calculation-including gradient descent optimization, a root-finding algorithm, or a decision tree supervised learning technique, for example.

At box 810, the time-optimal motion plan is used by the machine tool to perform the multi-step machining operation. The time-optimal motion plan is computed once by the programming language software and then used many times by the machine tool. For example, considering the workpiece 402 of FIG. 4, the machining program can be written with motion primitives defining the steps to drill each of the many holes; the motion plan is then computed to include the time-optimal drill-retreat-move-drill sequence for all of the holes, and the motion plan is used by the machine tool for each workpiece. Considering that many hundreds or thousands of workpieces may be machined using the same motion plan, the cycle time reduction of the time-optimal motion plan can yield a tremendous improvement in machine tool productivity. This productivity improvement is made possible by the programming language software with motion primitives, and the corresponding calculation of the time-optimal motion plan.

The use of motion primitives in a machining program provides a convenient way to produce a time-optimal motion plan for a multi-step machining operation, while simplifying the process of writing the machining program by eliminating guesswork for parameters like exit velocity and height of an upward air cut step. An advantageous enhancement can be added by incorporating automatic collision avoidance in the programming language software, so that the motion plan which is generated has the minimum overall cycle time while also being collision-free. Techniques for collision avoidance planning using motion primitives are discussed below.

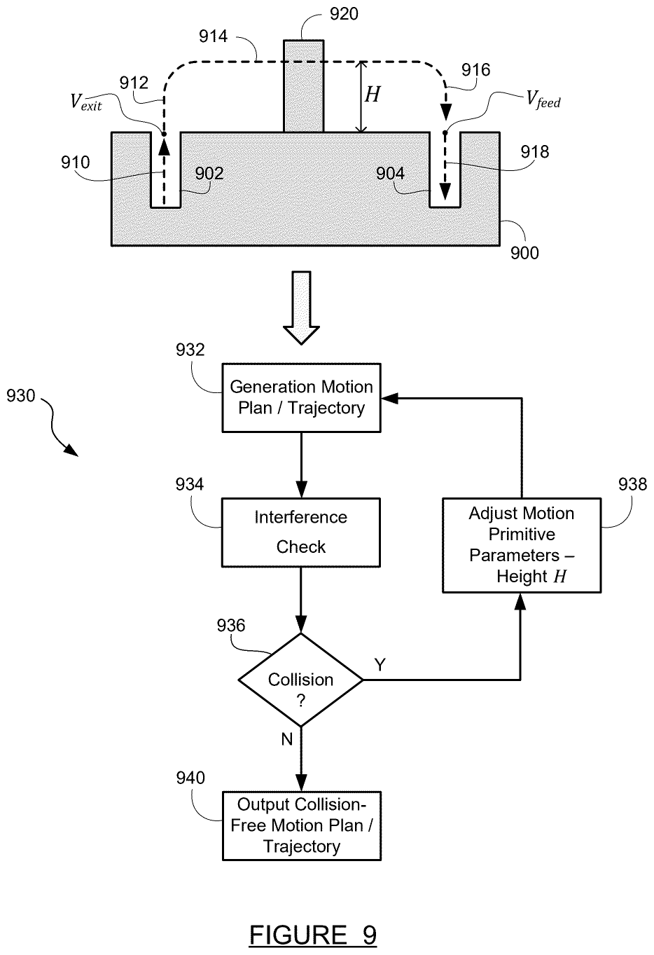

FIG. 9 is an illustration of a two-hole drilling operation using motion primitives in an environment with an obstacle, along with a flowchart diagram 930 of a method for time-optimal collision-free motion planning using a programming language software application with motion primitives in a machining program, according to embodiments of the present disclosure.

At the top of FIG. 9, a workpiece 900 is illustrated with a first hole 902 and a second hole 904. Using the techniques described in detail above, motion primitives are used in a machining program to define the multi-step machining operation. This includes a Retreat motion primitive depicted by arrow 910, an Aircut-Up motion primitive 912, an Aircut-XY motion primitive 914 and an Aircut-Down motion primitive 916 which are combined into a curved arrow as shown (as these motions are computed to happen concurrently by the programming language software), and a Drill motion primitive indicated by arrow 918. Each of the motion primitives includes a first and second point, with position, velocity and acceleration states (some of which are variable and to be determined) defined at each point. These include the exit velocity Vₑₓᵢₜ, the trajectory height H, and the drilling feed speed V_{feed}, among others.

An obstacle 920 exists in a region “above” the workpiece 900—that is, in the space where the air cut motion takes place when the tool moves from the first hole 902 to the second hole 904. The obstacle 920 could be part of the workpiece 900 as illustrated here, or the obstacle 920 could be a tooling fixture, for example. Regardless, the machine tool motion must be defined so that the tool does not contact the obstacle 920.

The flowchart diagram 930 depicts a method for time-optimal collision-free motion planning for a multi-step machining operation using the motion primitives as described above. At a box 932, a motion plan for the multi-step machining operation is generated as discussed earlier and shown in the flowchart diagram of FIG. 8. This includes computing the complete motion plan for the machining operation which has the minimum total cycle time, by performing an iterative computation to determine values of the interrelated variables Vₑₓᵢₜ and H, while also performing the Aircut-Up, Aircut-XY and Aircut-Down steps concurrently. The motion plan computed at the box 932 describes tool position, velocity and acceleration throughout the complete machining operation. This means that the spatial trajectory of the tip of the tool is known from the motion plan, and can be checked for interferences.

At box 934 the tool trajectory is checked for interference (collision) with the obstacle 920 and any other obstacles which exist in the workspace. This is a straightforward calculation in a computer aided design (CAD) or similar system using the 3D geometry of the tool trajectory and the obstacle 920.

At decision diamond 936, it is determined whether a collision was detected in the interference check box 934. If so, then at box 938, one or more parameters of the motion primitives are adjusted, and the motion plan and trajectory are regenerated at the box 932. In the example shown in FIG. 9, the height parameter H is adjusted upward at the box 938 before regenerating the trajectory at the box 932. The amount that H needs to be increased in order to avoid collision between the trajectory and the obstacle 920 may be calculated, or at least estimated closely, by the CAD software. Adjusting the value of H necessitates a complete regeneration of the motion plan at the box 932, including performing the iterative computation to find a motion plan with the minimum overall cycle time. This is because, when H must be increased to avoid a collision, the value of Vₑₓᵢₜ may be increased, which may shorten the time for the Retreat step, and it also affects the motion profile of the Aircut-XY step.

After the motion plan and trajectory are regenerated at the box 932, the interference check is again performed at the box 934, and the collision determination is again made at the decision diamond 936. There is no guarantee that the second generation motion plan will be collision-free, depending on the geometry of the tool trajectory and the obstacle 920. However, a collision-free trajectory should be able to be generated within a few loops through the box 932, each one using a different value of H until no trajectory-obstacle interference is present. A technique for identifying a critical point of interference and a corresponding offset to avoid a collision was described in detail in the '147 application.

When it is determined at the decision diamond 936 that no interference exists between the obstacle and the trajectory of the latest generated motion plan, then at box 940 the motion plan is output by the programming language software application (which performs the steps of the flowchart diagram 930). The motion plan is then used by the machine tool to perform the multi-step machining operation in a time-optimal fashion while avoiding tool-obstacle collision.

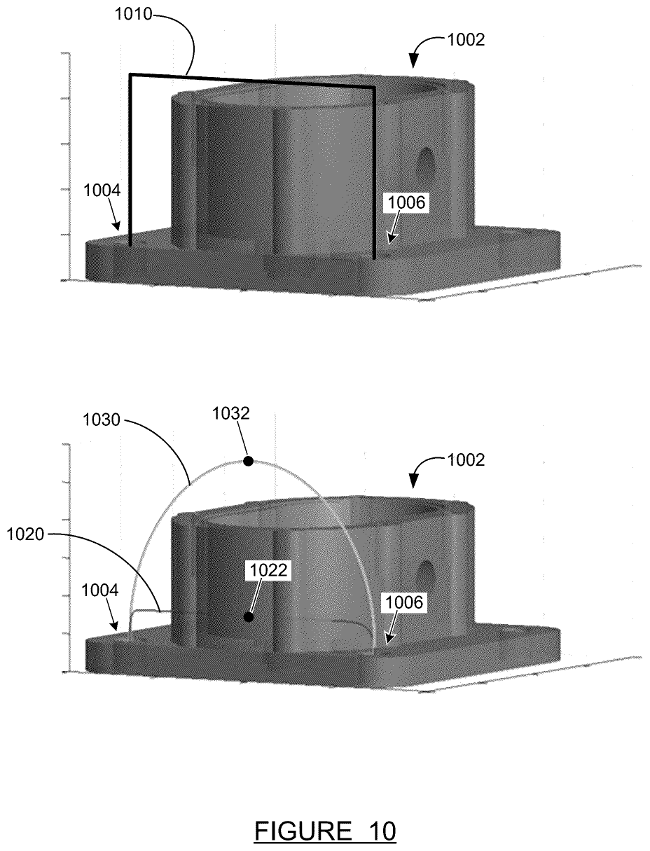

FIG. 10 is an illustration of a collision avoidance tool trajectory computed using traditional motion planning methods, and a collision avoidance tool trajectory computed using the programming language software with motion primitives and automatic collision avoidance planning according to embodiments of the present disclosure.

At the top of FIG. 10, a workpiece 1002 is illustrated with a plurality of holes, including a first hole 1004 and a second hole 1006. In the same manner discussed above, the machine tool performs a multi-step machining operation to drill the hole 1004 then the hole 1006, among others. Using traditional motion programming methods, after drilling and extracting the tool from the hole 1004, an air cut step would be defined to a height known to be above the top of the workpiece 1002 in order to avoid any tool-workpiece collision. Then a lateral air cut step would be defined to move the tool over into axial alignment with the hole 1006, followed by an air cut step down to the top of the hole 1006, which would then be drilled.

A trajectory 1010 is the result of the traditional motion programming method described above. The trajectory 1010 performs each air cut motion separately and independently. This results in a vertical air cut upward from the hole 1004, a horizontal or lateral air cut across to the axis of the hole 1006, and a vertical air cut downward. While the trajectory 1010 appears to be an efficient motion, in reality the stopping between each step and the non-concurrent up/across/down air cut steps cause the cycle time to be longer than optimal.

At the bottom of FIG. 10, the same workpiece 1002 is illustrated with the same first hole 1004 and second hole 1006. Using the motion primitive-based method of the present disclosure, a trajectory 1020 is computed which minimizes the cycle time of the extract/move/drill sequence for the holes 1004 and 1006. The trajectory 1020 passes through a point 1022 at the height H1 which is calculated by the programming language software during the motion plan iterative computation described above. It can be seen that the trajectory 1020 performs the Aircut-Up, Aircut-XY and Aircut-Down motion primitive steps concurrently, as indicated by the rounded corners of the trajectory 1020.

The trajectory 1020 clearly interferes with the workpiece 1002 and needs to be modified to avoid the collision. Using the method of FIG. 9, the motion primitive parameters are adjusted at the box 938 and the trajectory is regenerated at the box 932 until, after some number of loops around the flowchart, a collision-free trajectory is generated and is output at the box 940. The final motion plan has a collision-free trajectory 1030 which passes through a point 1032 at a final height of H2. It can be seen that the height H2 is significantly higher than the top of the workpiece 1002, and it might seem that the trajectory 1030 would therefore have a long cycle time. However, in simulations of the machining scenario depicted in FIG. 10, the trajectory 1030 actually has a 44% reduction in cycle time compared to the trajectory 1010 generated using traditional motion programming methods. This is possible because, using the motion primitive-based method, all of the horizontal/lateral tool motion can be accomplished during the Aircut-Up and Aircut-Down steps to the height H2. In addition, the tool does not stop after the hole extraction (Retreat), which allows Vₑₓᵢₜ to be maximized and shortens the duration of the Aircut-Up step. Finally, the Aircut-Down step can be completed at an axial speed of V_{feed} rather than zero, which shortens the duration of the Aircut-Down step and the Drill step.

It is emphasized that the calculation of the collision-free time-optimal trajectory 1030 is performed completely automatically by the programming language software, by simply defining the machining program using the motion primitives, and providing the workpiece geometry to enable collision avoidance.

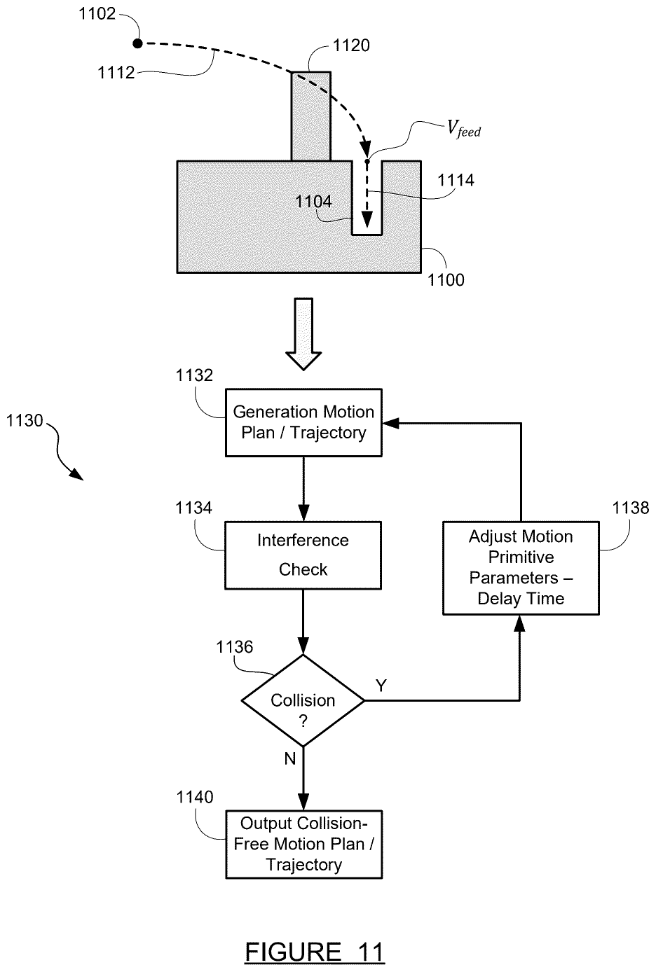

FIG. 11 is an illustration of a hole drilling operation with an initial approach step using motion primitives in an environment with an obstacle, along with a flowchart diagram 1130 of a method for time-optimal collision-free motion planning using a programming language software application with motion primitives in a machining program, according to other embodiments of the present disclosure.

At the top of FIG. 11, a workpiece 1100 is illustrated with an initial point 1102 and a hole 1104. In this example, the point 1102 is an initial staging point, such as where the tool is positioned while waiting for the workpiece 1100 to be placed in a fixture, and the hole 1104 is the first hole to be machined in the workpiece 1100. Using the techniques described in detail above, motion primitives are used in a machining program to define the multi-step machining operation. This includes a combined Aircut-XY and Aircut-Down step depicted by curved arrow 1112 (these motions are computed to happen concurrently by the programming language software), and a Drill motion primitive indicated by arrow 1114. Each of the motion primitives includes a first and second point, with position and velocity states defined at each point. These include the drilling feed speed V_{feed} as indicated, among others.

An obstacle 1120 exists in a region above the workpiece 1100 that is, in the space where the air cut motion takes place when the tool moves to the hole 1104. Again, the machine tool motion must be defined so that the tool does not contact the obstacle 1120. In this example, rather than adjusting the height parameter H (as there is no Aircut-Up step), a delay time can be added before starting the Aircut-Down motion during the Aircut-XY motion.

The flowchart diagram 1130 depicts a method for time-optimal collision-free motion planning for a multi-step machining operation using the motion primitives as described above. At a box 1132, a motion plan for the multi-step machining operation is generated as discussed earlier and shown in the flowchart diagram of FIG. 8. This includes computing the motion plan for the machining operation which has the minimum total cycle time to complete the Aircut-XY and Aircut-Down steps and arrive at the point at the top of the hole 1104 with a downward axial velocity of V_{feed}. The motion plan computed at the box 1132 describes tool position, velocity and acceleration throughout the machining operation, so that the spatial trajectory of the tip of the tool is known from the motion plan, and can be checked for interferences.

At box 1134 the tool trajectory (the combined air cut motion 1112) is checked for interference (collision) with the obstacle 1120 and any other obstacles which exist in the workspace, in the manner described earlier with respect to FIG. 9.

At decision diamond 1136, it is determined whether a collision was detected in the interference check box 1134. If so, then at box 1138, parameters of the motion primitives are adjusted, and the motion plan and trajectory are regenerated at the box 1132. In the example shown in FIG. 11, a delay time is added before beginning the Aircut-Down motion during the Aircut-XY motion. That is, from the point 1102, a purely horizontal/lateral motion is started using maximum effort (i.e., Jₘₐₓ to Aₘₐₓ; Aₘₐₓ to Vₘₐₓ) based on machine mechanical limits, and after some delay time the downward acceleration is initiated, using a motion profile which causes the downward velocity to end at V_{feed} when reaching the top of the hole 1104. Techniques for calculating a motion profile for this type of combined lateral and axial motion were described in detail in the '147 application. The amount of delay time that needs to be added in order to avoid collision between the trajectory and the obstacle 1120 may be estimated using any suitable technique-such as based on the amount of penetration of the trajectory with the obstacle. Adjusting the time delay necessitates a complete regeneration of the motion plan at the box 1132 using the iterative technique to identify the velocity profile which results in a minimum cycle time. This is because the delay causes less time to be available for the Aircut-Down step, and means that the Aircut-XY step should be started at maximum effort; both of the motions must therefore be recalculated with the designated synchronization.

After the motion plan and trajectory are regenerated at the box 1132, the interference check between the air cut motion 1112 and the obstacle 1120 is again performed at the box 1134, and the collision determination is again made at the decision diamond 1136. Looping around the flowchart diagram 1130 a few times may be necessary, after which a collision-free and time-optimal trajectory should be identified.

When it is determined at the decision diamond 1136 that no interference exists between the obstacle and the trajectory of the latest generated motion plan, then at box 1140 the motion plan is output by the programming language software application. The motion plan is then used by the machine tool to perform the multi-step machining operation in a time-optimal fashion while avoiding tool-obstacle collision.

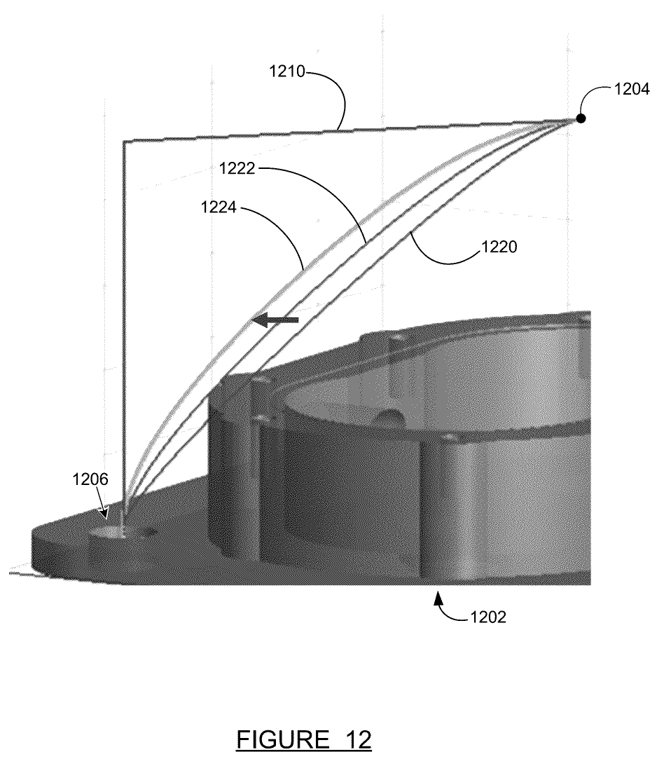

FIG. 12 is an illustration of a collision avoidance tool trajectory computed using traditional motion planning methods, and collision avoidance tool trajectories computed with different time delays using the programming language software with motion primitives and automatic collision avoidance planning according to embodiments of the present disclosure.

A workpiece 1202 is illustrated with a plurality of holes, as with the workpieces discussed in connection with earlier figures. In this scenario, the tip of the drilling tool is positioned at a point 1204 while the workpiece 1202 is placed into a fixture, and a hole 1206 is the first hole to be drilled. Thus, a time-optimal collision-free path needs to be computed from the point 1204 to the top of the hole 1206 to begin drilling.

Using traditional motion programming methods, a lateral air cut motion would be made first, followed by an axial air cut motion to the top of the hole 1206 where the tool would stop, after which the drilling step would commence. This motion plan results in a “trajectory” 1210 as depicted on FIG. 12. As discussed before regarding motion plans defined using traditional programming commands, the trajectory 1210 not only goes out of its way, but also stops at the end of each motion step. It is therefore easy to envision a motion plan computed from motion primitives having a much shorter cycle time.

Using the motion primitive-based method of the present disclosure, a trajectory 1220 is computed which minimizes the cycle time of the move/drill sequence from the point 1204 to the hole 1206. The trajectory 1220 includes an Aircut-XY motion primitive and an Aircut-Down motion primitive which are performed concurrently (having at least some overlap), such that the trajectory 1220 arrives at the top of the hole 1206 having a downward velocity of V_{feed}, whereupon drilling can commence immediately and without any delay, speed-up or slow-down.

The trajectory 1220 interferes with the workpiece 1202 and needs to be modified to avoid the collision. Using the method of FIG. 11, the calculation of the motion plan from the motion primitive parameters is adjusted at the box 1138 and the trajectory is regenerated at the box 1132. Specifically, a delay time is added after beginning the Aircut-XY motion and before beginning the Aircut-Down motion. The appropriate delay time may be calculated (estimated) in any fashion deemed suitable-such as a percentage (e.g., 5%) of the overall trajectory time of the combined Aircut-XY/Aircut-Down motion, for example.

A trajectory 1222 is the result of motion plan generation after the first delay time addition. At the box 1134, an interference check is performed and it is determined that the trajectory 1222 still interferes with the workpiece 1202. It can be seen in FIG. 12 that the amount of workpiece interference with the trajectory 1222 is much less than with the trajectory 1220. Nonetheless, at the decision diamond 1136 the process moves again to the box 1138 where the delay time is increased.

A trajectory 1224 is the result of motion plan generation after the second delay time addition/increase. At the box 1134, an interference check is performed and it is determined that the trajectory 1224 does not interfere with the workpiece 1202, as can be seen in FIG. 12. Therefore, at the decision diamond 1136 the process moves to the box 1140 where the most recently generated motion plan with the trajectory 1224 is used by the machine tool to perform the machining operation—that is, move from the initial staging point 1204 to drill the hole 1206. As should be understood by now, the complete machining program for the workpiece 1202 would include, after the motion primitives which were used to generated the trajectory 1224, sets of motion primitives (Retreat; Aircut-Up; Aircut-XY; Aircut-Down; Drill) for drilling each of the remaining workpiece holes. The motion plan trajectory for each set of motion primitives would be interference checked by the programming language software using the techniques depicted on FIGS. 9 and 10. The final motion plan including machine tool commands for performing all of the drilling operations on the workpiece 1202 would be automatically calculated by the programming language software to include time-optimal collision-free trajectories for each hole-to-hole move.

In simulations of the FIG. 12 scenario, the motion plan with the trajectory 1224, computed as described above, yielded a cycle time reduction of over 45% compared to the trajectory 1210 generated using traditional motion programming methods. This is possible because of the overlap between the lateral and vertical motions, and the fact that the tool does not stop before beginning drilling. Again it is emphasized that the calculation of the collision-free time-optimal trajectory 1224 is performed completely automatically by the programming language software, by simply defining the machining program using the motion primitives (Aircut-XY, Aircut-Down, Drill), and providing the workpiece geometry to enable collision avoidance.

Because motion programs for machining operations are typically defined for a particular workpiece and then used many times (often used for machining many thousands of individual workpieces, if not more), the rapid machining motion primitives of the present disclosure offer the potential for tremendous time savings and efficiency. In addition, the machine tool which performs the operations undergoes less wear and tear, because the elimination of many starts and stops reduces the severity of accelerations in multiple parts of the machining operation. Furthermore, the use of motion primitives in a machining program dramatically simplifies the creation of collision-free motion plans, because the programming language software can automatically perform interference check calculations while optimizing boundary condition states to provide a minimum cycle time. These benefits all accrue to a financial benefit for companies that implement the disclosed rapid motion primitives for their machining operations.

Throughout the preceding discussion, various computers and controllers are described and implied. It is to be understood that the software applications and modules of these computers and controllers are executed on one or more electronic computing devices having a processor and a memory module. In particular, this includes the machine controller 160 of FIG. 1, and/or an optional other computer which may be provided to run the programming language software, read a machining program and compute a time-optimal motion plan for the multi-step machining operation. Specifically, the processor in the controller or the other computer is configured to read a machining program containing motion primitives and compute a time-optimal motion plan as depicted in the various figures and according to the method steps of FIGS. 8, 9 and 11, using the techniques described above.

While a number of exemplary aspects and embodiments of the methods for machinery motion primitives have been discussed above, those of skill in the art will recognize modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method for motion programming of a machine tool, said method comprising:
providing a programming language including a set of motion primitives, where each motion primitive defines a cutting step or an air cut step from a first point to a second point with position and velocity boundary conditions at the first and second points;
reading a machining program written in the programming language, by a software application running on a computing device, where the machining program includes two or more of the motion primitives in sequence describing a machining operation including at least one air cut step and one cutting step, and the first point of each motion primitive in the machining program has boundary conditions matching the second point of a preceding motion primitive;
computing a motion plan defining a motion of a tool according to the machining program, by the software application, where the motion plan includes at least one non-static boundary condition between steps, and a velocity profile of each step and values of any variable boundary conditions are calculated using an iterative computation to yield a minimum total time for the motion plan; and
using the motion plan by the machine tool to perform the machining operation.

2. The method according to claim 1 wherein the iterative computation includes iteratively revising the velocity profile of each step and the values of the variable boundary conditions and recomputing the motion plan until a motion plan having a minimum total time is identified.

3. The method according to claim 2 including using a gradient descent method, a root-finding algorithm or a decision tree algorithm to identify the motion plan having the minimum total time.

4. The method according to claim 1 wherein the set of motion primitives includes a Drill motion primitive defining a hole drilling step in an axial direction into a workpiece, a Retreat motion primitive defining a tool extraction from a hole in the axial direction, an Aircut-Up motion primitive defining an air cut tool motion in the axial direction away from the workpiece, an Aircut-XY motion primitive defining an air cut tool motion in a lateral direction normal to the axial direction, and an Aircut-Down motion primitive defining an air cut tool motion in the axial direction toward the workpiece.

5. The method according to claim 4 wherein the motion primitives defining air cut tool motions include constraints of machine maximum velocity, maximum acceleration and maximum jerk, the Aircut-Up motion primitive has a zero axial velocity boundary condition at the second point, the Aircut-Down motion primitive has a zero axial velocity boundary condition at the first point, the Aircut-XY motion primitive has zero lateral velocity boundary conditions at the first point and the second point, and the Drill motion primitive has a maximum velocity of a drilling feed speed and a zero velocity boundary condition at the second point.

6. The method according to claim 4 wherein the software application computes the tool motions with a variable non-static boundary condition between the Retreat motion primitive and the Aircut-Up motion primitive when used in sequence in the machining program, and the software application computes the tool motions with a non-static boundary condition between the Aircut-Down motion primitive and the Drill motion primitive when used in sequence in the machining program.

7. The method according to claim 6 wherein the software application computes the tool motions of the Aircut-Up motion primitive, the Aircut-XY motion primitive and the Aircut-Down motion primitive to be performed concurrently in the motion plan when used in sequence the machining program.

8. The method according to claim 4 wherein the machining operation is drilling one or more holes in the workpiece and the machining program includes at least one sequence of a Retreat motion primitive, an Aircut-Up motion primitive, an Aircut-XY motion primitive, an Aircut-Down motion primitive and a Drill motion primitive, and the software application computes the tool motions with a non-static boundary condition between the Aircut-Down motion primitive and the Drill motion primitive, and the software application optimizes values of a variable exit velocity between the Retreat motion primitive and the Aircut-Up motion primitive and a variable axial position of the second point of the Aircut-Up motion primitive and the first point of the Aircut-Down motion primitive.

9. The method according to claim 4 wherein the machining operation is a pecking operation where a hole is drilled in the workpiece in a plurality of stages of increasing hole depth, where the machining program includes the plurality of sequences of a Drill motion primitive, a Retreat motion primitive and an Aircut-Down motion primitive, each of the Aircut-Down motion primitives having an axial position of the second point equal to the axial position of the second point of the preceding Drill motion primitive, and each of the Drill motion primitives having an axial position of the second point further into the workpiece than the axial position of the second point of the preceding Drill motion primitive, and the software application computes the tool motions with a non-static boundary condition between the Aircut-Down motion primitive and the Drill motion primitive.

10. The method according to claim 4 wherein the machining operation is a two-stage drilling operation using different speeds, where the machining program includes two Drill motion primitives in sequence, a first Drill motion primitive having a first feed speed and a second Drill motion primitive having a second feed speed different than the first feed speed, and where the software application computes the tool motions with a non-static transition from the first feed speed to the second feed speed.

11. The method according to claim 1 wherein the machine tool is a multi-axis industrial robot or a multi-axis numerically-controlled machine.

12. The method according to claim 1 wherein the motion primitives also include acceleration boundary conditions at the first and second points.

13. A method for motion programming of a machine tool, said method comprising:
providing a programming language including a set of motion primitives, where each motion primitive defines a cutting step or an air cut step from a first point to a second point with position, velocity and acceleration boundary conditions at the first and second points, where the motion primitives includes a Drill motion primitive defining a hole drilling step in an axial direction into a workpiece, a Retreat motion primitive defining a tool extraction from a hole in the axial direction, an Aircut-Up motion primitive defining an air cut tool motion in the axial direction away from the workpiece, an Aircut-XY motion primitive defining an air cut tool motion in a lateral direction normal to the axial direction, and an Aircut-Down motion primitive defining an air cut tool motion in the axial direction toward the workpiece;
reading a machining program written in the programming language, by a software application running on a computing device, where the machining program includes two or more of the motion primitives in sequence describing a machining operation including at least one air cut step and one cutting step, and the first point of each motion primitive in the machining program has boundary conditions matching the second point of a preceding motion primitive;
computing a motion plan defining a motion of a tool according to the machining program, by the software application, where the motion plan includes at least one non-static boundary condition between steps, and a velocity profile of each step and values of any variable boundary conditions are calculated using an iterative computation to yield a minimum total time for the motion plan; and
using the motion plan by the machine tool to perform the machining operation.

14. A machine tool motion programming system, said system comprising:
a computing device having a processor and memory, said computing device executing a software application configured for;
reading a machining program written in a programming language including a set of motion primitives, where each motion primitive defines a cutting step or an air cut step from a first point to a second point with position, velocity and acceleration boundary conditions at the first and second points,
where the machining program includes two or more of the motion primitives in sequence describing a machining operation including at least one air cut step and one cutting step, and the first point of each motion primitive in the machining program has boundary conditions matching the second point of a preceding motion primitive; and
computing a motion plan defining a motion of a tool according to the machining program, where the motion plan includes at least one non-static boundary condition between steps, and a velocity profile of each step and values of any variable boundary conditions are calculated using an iterative computation to yield a minimum total time for the motion plan;
providing the motion plan to a machine tool to perform the machining operation.

15. The system according to claim 14 wherein the iterative computation includes iteratively revising the velocity profile of each step and the values of the variable boundary conditions and recomputing the motion plan until a motion plan having a minimum total time is identified.

16. The system according to claim 14 wherein the set of motion primitives includes a Drill motion primitive defining a hole drilling step in an axial direction into a workpiece, a Retreat motion primitive defining a tool extraction from a hole in the axial direction, an Aircut-Up motion primitive defining an air cut tool motion in the axial direction away from the workpiece, an Aircut-XY motion primitive defining an air cut tool motion in a lateral direction normal to the axial direction, and an Aircut-Down motion primitive defining an air cut tool motion in the axial direction toward the workpiece.

17. The system according to claim 16 wherein the motion primitives defining air cut tool motions include constraints of machine maximum velocity, maximum acceleration and maximum jerk, the Aircut-Up motion primitive has a zero axial velocity boundary condition at the second point, the Aircut-Down motion primitive has a zero axial velocity boundary condition at the first point, the Aircut-XY motion primitive has zero lateral velocity boundary conditions at the first point and the second point, and the Drill motion primitive has a maximum velocity of a drilling feed speed and a zero velocity boundary condition at the second point.

18. The system according to claim 16 wherein the software application computes the tool motions with a variable non-static boundary condition between the Retreat motion primitive and the Aircut-Up motion primitive when used in sequence in the machining program, and the software application computes the tool motions with a non-static boundary condition between the Aircut-Down motion primitive and the Drill motion primitive when used in sequence in the machining program.

19. The system according to claim 18 wherein the software application computes the tool motions of the Aircut-Up motion primitive, the Aircut-XY motion primitive and the Aircut-Down motion primitive to be performed concurrently in the motion plan when used in sequence the machining program.

20. The system according to claim 16 wherein the machining operation is drilling one or more holes in the workpiece and the machining program includes at least one sequence of a Retreat motion primitive, an Aircut-Up motion primitive, an Aircut-XY motion primitive, an Aircut-Down motion primitive and a Drill motion primitive, and the programming language software application computes the tool motions with a non-static boundary condition between the Aircut-Down motion primitive and the Drill motion primitive, and the software application optimizes values of a variable exit velocity between the Retreat motion primitive and the Aircut-Up motion primitive and a variable axial position of the second point of the Aircut-Up motion primitive and the first point of the Aircut-Down motion primitive.

21. The system according to claim 16 wherein the machining operation is a pecking operation where a hole is drilled in the workpiece in a plurality of stages of increasing hole depth, where the machining program includes the plurality of sequences of a Drill motion primitive, a Retreat motion primitive and an Aircut-Down motion primitive, each of the Aircut-Down motion primitives having an axial position of the second point equal to the axial position of the second point of the preceding Drill motion primitive, and each of the Drill motion primitives having an axial position of the second point further into the workpiece than the axial position of the second point of the preceding Drill motion primitive, and the software application computes the tool motions with a non-static boundary condition between the Aircut-Down motion primitive and the Drill motion primitive.

22. The system according to claim 16 wherein the machining operation is a two-stage drilling operation using different speeds, where the machining program includes two Drill motion primitives in sequence, a first Drill motion primitive having a first feed speed and a second Drill motion primitive having a second feed speed different than the first feed speed, and where the software application computes the tool motions with a non-static transition from the first feed speed to the second feed speed.

23. The system according to claim 14 further comprising the machine tool, where the machine tool is a multi-axis industrial robot or a multi-axis numerically-controlled machine.

24. The system according to claim 14 wherein the computing device is a controller of the machine tool, or the computing device is a computer which provides the motion plan to the controller of the machine tool.
